(19) United States
(12) Patent Application Publication
(10) Pub. No.: US 2014/0265945 A1
(43) Pub. Date: Sep. 18, 2014

(54) Electric Drive System

(71) Applicant: INFINEON TECHNOLOGIES AUSTRIA AG, Villach (AT)

(72) Inventor: Gerald Deboy, Klagenfurt (AT)

(21) Appl. No.: 13/839,652

(22) Filed: Mar. 15, 2013

(51) Int. Cl. B60L 11/18

(52) U.S. Cl. CPC B60L 11/1851
USPC 318/139

(57) ABSTRACT

An electric drive system includes a rechargeable battery and a power supply bus. A first power converter circuit is coupled between the rechargeable battery and the power supply bus. A motor is configured to be coupled to the power supply bus. A control circuit is configured to operate the first power converter circuit in one of a power supply mode in which the first power converter circuit supplies at least one of an alternating current and a rectified alternating current to the power supply bus, and a battery charging mode in which the first power converter circuit charges the rechargeable battery.

### TECHNICAL FIELD

Embodiments of the present invention relate to an electric drive system, in particular an electric drive system implemented in a vehicle.

### BACKGROUND

With an increasing interest in sustainable energy production there is a focus on electrically driven vehicles, such as electrically driven cars or motorcycles, that include a drive system with a rechargeable battery, and an electric motor supplied by the battery. In a conventional electric car, the battery supplies a DC (direct current) power to an inverter that generates an AC (alternating current) power from the DC power, and an asynchronous electric motor receives the AC power. Other loads, such as an air-cooling system, motors for seat adjustments, window lifters and the like, an audio and navigation system may additionally be connected to the battery.

Conventionally, there is a power cable in the vehicle from the battery to the individual loads. The battery DC voltage is, for example, about 400V in cars, and between 600V and 800V in trucks or busses. In case of an emergency, such as an accident, a connection between the battery and the loads needs to be safely disconnected. For switching those DC voltages with a voltage level in the range of several hundred volts relays are required that safely prevent electric arcs at the time of switching. Those relays are relatively expensive.

For charging the battery the vehicle may include an on-board charger that can be connected to a power grid when the vehicle is parking. However, usually a maximum power that can be delivered by the on-board charger is relatively low as compared with the capacitance (the maximum output power) of the battery, so that completely charging the battery may take several hours.

### SUMMARY OF THE INVENTION

A first embodiment relates to an electric drive system. The electric drive system includes a rechargeable battery, a power supply bus, a first power converter circuit coupled between the rechargeable battery and the power supply bus, a motor configured to be coupled to the power supply bus, and a control circuit. The control circuit is configured to operate the first power converter circuit in one of a power supply mode in which the first power converter circuit supplies an alternating voltage to the power supply bus, and a battery charging mode in which the first power converter circuit charges the rechargeable battery.

A second embodiment relates to a method. The method includes operating a first power converter circuit coupled between a rechargeable battery and a power supply bus in one of a power supply mode in which the first power converter circuit supplies at least one of an alternating current and a rectified alternating current to the power supply bus, and a battery charging mode in which the first power converter circuit charges the rechargeable battery from an external power source configured to be coupled to the power supply bus. The method further includes driving a motor connected to the power supply bus in the drive mode.

### BRIEF DESCRIPTION OF THE DRAWINGS

Examples will now be explained with reference to the drawings. The drawings serve to illustrate the basic principle, so that only aspects necessary for understanding the basic principle are illustrated. The drawings are not to scale. In the drawings the same reference characters denote like features.

FIG. 1 illustrates a one embodiment of an electric drive system including a rechargeable battery, a power converter circuit, a power supply bus, a switching circuit, a motor, and a control circuit;

FIG. 2 illustrates one embodiment of a switching circuit of the electric drive system shown in FIG. 1;

FIG. 3 illustrates a first embodiment of the power converter circuit and the control circuit;

FIG. 4 illustrates a second embodiment of the power converter circuit and the control circuit;

FIG. 5 shows timing diagrams illustrating the operating principle of the power converter circuit and the control circuit in a power supply mode;

FIG. 6 illustrates the operating principle of the power converter circuit and the control circuit in a battery charging mode;

FIG. 7 shows timing diagrams illustrating the operating principle of the power converter circuit and the control circuit in the battery charging mode;

FIG. 8 illustrates one embodiment of a control unit implemented in the control circuit and controlling the battery charging mode;

FIG. 9 illustrates one embodiment of an electric drive system that includes additional power converter circuits;

FIG. 10 illustrates one embodiment of a power converter circuit of FIG. 9;

FIG. 11 illustrates another embodiment of a power converter circuit of FIG. 9;

FIG. 12 illustrates one embodiment of the power converter circuit of FIG. 1 that includes a DC/DC power converter stage and a DC/AC power converter stage;

FIG. 13 shows waveforms of signals that may occur in the power converter circuit illustrated in FIG. 12;

FIG. 14 illustrates one embodiment of the DC/DC power converter stage of FIG. 12;

FIG. 15 illustrates one embodiment of an electric drive system that additionally includes a generator;

FIG. 16 that includes FIGS. 16A and 16B, shows ways of coupling the generator to the power converter circuit;

FIG. 17 illustrates one embodiment of an electric drive system that includes a plurality of batteries and a plurality of power converter circuits;

FIG. 18 illustrates one embodiment of a power converter circuit that includes a battery with a plurality of battery sections and a power converter circuit with a plurality of power converter subcircuits;

FIG. 19 illustrates an embodiment of an electric drive system including a 3-phase power supply bus;

FIG. 20 illustrates a first embodiment of the power converter circuit of FIG. 19;

FIG. 21 illustrates a second embodiment of the power converter circuit of FIG. 18;

FIG. 22 illustrates yet another embodiment of an electric drive system;

FIG. 23 shows a timing diagram of an embodiment of a supply current in the system of FIG. 22; and

FIG. 24 illustrates one embodiment of an unfolding bridge in the system of FIG. 22.

### DETAILED DESCRIPTION OF ILLUSTRATIVE EMBODIMENTS

In the following detailed description, reference is made to the accompanying drawings. The drawings form a part of the description and by way of illustration show specific embodiments in which the invention may be practiced. It is to be understood that the features of the various embodiments described herein may be combined with each other, unless specifically noted otherwise.

Embodiments of the invention are disclosed in a specific context, namely in context with an electric drive system in an electrically driven automobile. However, these embodiments are not restricted to be used in an automobile, but may also be used in any other type of electrically driven land vehicle, such as a truck, a bus, a motorcycle, a motor scooter, or the like, in a water vehicle, or an air vehicle.

FIG. 1 illustrates a first embodiment of an electric drive system. The electric drive system, that will simply be referred to as drive system in the following, includes a rechargeable battery 1, a power supply bus 4, a power converter circuit 2 coupled between the rechargeable battery 1 and the power supply bus 4, a motor M configured to be coupled to the power supply bus 4, and a control circuit 3 configured to control an operation of the power converter circuit 2. The rechargeable battery 1 supplies a battery voltage V1 between battery terminals 11, 12. The rechargeable battery can be a conventional rechargeable battery, such as a battery including Lithium-ion battery cells. The battery voltage V1 is dependent on the specific type of battery. According to one embodiment, the battery 1 is configured to supply a battery voltage of several 100V. According to one embodiment, the battery 1 is selected such that a maximum battery voltage is about 400V. A drive system with this type of battery is, for example, used in an electric car, an electric motorcycle, or the like. According to further embodiments, the battery 1 is selected such that a maximum battery voltage V1 is between 600V and 800V. A drive system with this type of battery is, for example, used in an electrically drive truck or bus. The battery voltage V1 may vary dependent on a charge state of the battery 1.

The power converter circuit 2, that is coupled between the battery 1 and the power supply bus 4, is configured to be operated in one of a first operation mode and a second operation mode. In the first operation mode, that will be referred to as power supply mode or drive mode in the following, the power converter circuit 2 receives power from the battery 1 and supplies power to the power supply bus 4. The power received by the power converter circuit 2 from the battery 1 is a DC power, that is the battery voltage V1 is a direct voltage (DC voltage), and a corresponding battery current I1 is a direct current (DC). The power supplied by the power converter circuit 2 to the power supply bus 4 is an AC power that is, a supply voltage V2 provided by the power converter circuit 2 to the power supply bus is an alternating voltage (AC voltage) and a corresponding supply current I2 is an alternating current (AC).

In the battery charging mode, the power converter circuit 2 receives AC power from the power supply bus 4 and provides DC power to the battery terminals 11, 12 for charging the battery 1. The control circuit 3 controls the operation of the power converter circuit 2. The control circuit 3 is in signal communication with the power converter circuit 2 and provides at least one control signal (that is only schematically illustrated in FIG. 1) to the power converter circuit 2.

Referring to FIG. 1, the drive system further includes a motor M that is configured to be coupled to the power supply bus 4 and that is configured to receive AC power from the power supply bus 4 when the power converter circuit 2 is in the power supply mode. The motor M can be a conventional asynchronous motor, wherein a rotational speed of the motor M can be controlled by a frequency of one of the AC voltage V2, and the alternating current I2 supplied by the power converter circuit 2 in the power supply mode. This is explained in greater detail herein below.

Further, the drive system includes supply terminals 50, 51 that are configured to be coupled to the power supply bus 4 in order to supply AC power to the AC bus 4 when the power converter circuit 2 is in the battery charging mode. The power supply terminals 50, 51 can be coupled to a power source (not shown in FIG. 1), such as a conventional AC power grid, when the vehicle in which the drive system is implemented is parking.

Referring to FIG. 1, the drive system includes a switching circuit 5 coupled between the power supply bus 4 and the motor M, and coupled between the power supply bus 4 and the power supply terminals 50, 51. The switching circuit 5 is configured to either connect the power supply bus 4 to the motor M in order to drive the motor, or to connect the power supply bus 4 to the power supply terminals 50, 51 in order to receive energy from the external power source. According to one embodiment, the control circuit 3 also controls the switching circuit 5. In this embodiment, the control circuit 3 controls the switching circuit 5 to connect the power supply bus 4 to the motor M when the power converter circuit 2 is in the power supply mode, and controls the switching circuit 5 to connect the power supply bus 4 to the power supply terminals 50, 51 when the power converter circuit 2 is in the charging mode.

In the embodiment of FIG. 1, the power supply bus 4 includes two supply lines, namely a first line 41 and a second line 40. The first line 41 will be referred to as first phase in the following, and the second line 40 will be referred to as neutral in the following. This type of power supply bus including one phase can be referred to as single phase (1-phase) power supply bus.

FIG. 2 illustrates one embodiment of a switching circuit 5 that can be used in connection with a single phase power supply bus 4. In this embodiment, the switching circuit 5 includes two crossover switches 54, 55, namely a first crossover switch that is configured to connect the neutral 40 either to a first motor terminal M0 or to a first supply terminal 50, and a second crossover switch 55 that is configured to connect the first phase 51 either to a second motor terminal M1 or to a second supply terminal 51. When the power converter circuit 2 is in the power supply mode, the switches 54, 55 connect the phase 41 and the neutral 40 of the power supply bus 4 to the motor M. When the power converter circuit 2 is in the battery charging mode, the switches 54, 55 connect the phase 41 and the neutral 40 of the power supply bus 4 to the power supply terminals 50, 51. The switches 54, 55 can be implemented as conventional switches, such as relays or electronic switches. Electronic switches are, for example, transistors, thyristors, or the like.

The power converter circuit 2 can be implemented with a conventional bidirectional power converter topology. A “bidirectional power converter topology” is a power converter topology that allows a power transfer in two directions, which is, in the present embodiment, from the battery 1 to the power supply bus 4, and from the power supply bus 4 to the battery 1. For explanation purposes, two different embodiments of the power converter circuit 2 are explained with reference to FIGS. 3 and 4. It should be noted that the circuit topologies of FIGS. 3 and 4 are only examples. Many other bidirectional power converter topologies may be used as well, such as circuits with a VIENNA rectifier topology or a SWISS rectifier topology. These topologies are disclosed in Kolar, J. W.; Friedli, T., “The essence of three-phase PFC rectifier systems,” Telecommunications Energy Conference (INTELEC), 2011 IEEE 33rd International, pp. 1-27, Oct. 9-13, 2011, which is incorporated herein by reference in its entirety.

Referring to FIG. 3, the power converter circuit 2, in a drive system with a single phase power supply bus 1, includes one converter stage 21 connected between the battery terminal 11, 12 and the power supply bus 4. A modification of the power converter circuit 2 that can be used in connection with a 3-phase power supply bus is explained further below. Referring to FIG. 3, the power converter stage 21 includes a H-bridge with two half-bridges. A first half-bridge includes a first switch 61 and a second switch 62 that are connected in series between the battery terminals 11, 12. A second half-bridge includes a third switch 63 and a fourth switch 64 that are connected in series between the battery terminals 11, 12. Each of the first and second half-bridges includes an output, which is a circuit node common to the switches of the corresponding half-bridge. In the present embodiment, the output of the first half-bridge 61, 62 is coupled to the first phase 41, and the output of the second half-bridge 63, 64 is coupled to the neutral 40. An inductor 65, such as a choke, is connected to one of the outputs. In the present embodiment, the inductor 65 is connected between the output of the first half-bridge 61, 62 and the first phase 41. Optionally, an output capacitor is connected between those circuit nodes where an output voltage V21 of the converter stage 21 is available.

The switches 61-64 of the converter stage 21 can be implemented as conventional electronic switches, such as MOSFETs (Metal-Oxide-Semiconductor Field-Effect Transistors), IGBTs (Insulated Gate Bipolar Transistors), BJTs (Bipolar Junction Transistors), JFETs (Junction Field-Effect Transistors), on the basis of a conventional semiconductor material, such as silicon (Si), silicon carbide (SiC), gallium arsenide (GaAs). It is also possible to implement the individual switches as HEMTs (High Electron-Mobility Transistors), HEMTs, in particular as GaN-(gallium nitride)-HEMTs.

The converter stage 21 of FIG. 4 is based on the converter stage 21 of FIG. 3 and is different from the converter stage 21 in FIG. 3 in that the inductor 65 is connected between one of the battery terminals 11, 12 and the half-bridges. In the present embodiment, the inductor 65 is connected between the first battery terminal 11 and the half-bridges. The operating principle of the converter stages 21 of FIGS. 3 and 4 are basically the same. The difference between the two converter stages of FIGS. 3 and 4 is that the converter stage 21 of FIG. 3 can be operated as a boost converter in the battery charging mode, while the converter circuit 21 of FIG. 4 can be operated as buck converter in the battery charging mode.

Referring to FIGS. 3 and 4, the switches 61-64 of the converter stage 21 each receive a drive signal S61-S64. The drive signal received by each switch is configured to switch on or switch off the corresponding switch. The control circuit 3 outputs the drive signals S61-S64 for the individual switches 61-64. In the present embodiment, the control circuit 3 includes a first control unit 31 that controls operation of the power converter circuit 2 in the power supply mode (drive mode), and a second control unit 32 that controls operation of the power converter circuit 2 in the charging mode. The first control unit 31 will be referred to as drive control unit in the following, and the second control unit 32 will be referred to as charge control unit in the following. A central control unit 30 controls the drive control unit 31 and the charge control unit 32 and, dependent on a desired operation mode of the overall drive system, activates the drive control unit 31 to output drive signals S61-S64 for the individual switches, or activates the charge control unit 32 to output the drive signals S61-S64. It should be noted, that the block diagram illustrated in FIGS. 3 and 4 merely serves to illustrate the functionality of the control circuit 3 rather than its implementation. The individual function blocks, that will be explained in further detail below, may be implemented using a conventional technology that is suitable to implement the drive control unit 31 and the charge control unit 32. Specifically, these control units 31, 32, as well as the central control unit 30 may be implemented as analog circuits, digital circuits, or may be implemented using hardware and software, such as a microcontroller on which a specific software is running in order to implement the functionality of the control circuit 3.

The operating principle of the drive control unit 31 is explained with reference to FIG. 5 below, and the operating principle of the charge control unit 32 is explained with reference to FIG. 6 below.

FIG. 5 shows timing diagrams of the output current I21 of the converter stage 21, and of the drive signals S61-S64 of the individual switches. The output current of the converter stage 21 is the current provided by the converter stage 21 to the power supply bus 4. For explanation purposes, it is assumed that high signal levels of the drive signals S61-S64 illustrated in FIG. 5 represent signal levels that switch on the corresponding switch, while low signal levels represent signal levels that switch off the corresponding switch. The output voltage of the converter stage V21 corresponds to the output voltage V2 of the power converter circuit 2 in a drive system with a single phase power supply bus 4, and the output current I2 of the power converter circuit 2 corresponds to the output current of the converter stage 21. For explanation purposes, it is assumed that the converter stage 21, in the drive mode, is configured to generate the supply current I21 and I2, respectively, with a sinusoidal waveform that is schematically illustrated in FIG. 5. FIG. 5 shows one period with a positive half-period, and a negative half-period of the sinusoidal supply current I2, I21. The operating principle of the drive control unit 31, that controls the converter stage 21 to generate the sinusoidal supply current I21, is explained with reference to timing diagrams of the individual drive signals S61-S64 below.

In general, the drive control unit 31 can control the converter stage 21 to generate a positive supply current I2, I21, that is a supply voltage having the polarity as illustrated in FIGS. 3 and 4, and can control the converter stage 21 to generate a negative supply current, that is a supply current I21 having a polarity opposite to the polarity illustrated in FIGS. 3 and 4. An operation mode of the drive control unit 31 in which the drive control unit 31 controls the converter stage 21 to generate a positive output current I2, I21 will be referred to as first operation mode, and an operation mode in which the converter stage 21 generates a negative output current I21 will be referred to as a second operation mode of the drive control unit 31. In the first operation mode, the drive control unit 31 switches off the third switch 63, switches on the fourth switch 64 and switches on and off the first switch 61 and the second switch 62 in a pulse-width modulated (PWM) fashion. The first and second switches 61, 62 are switched on and off alternatingly so that the second switch 62 is switched on when the first switch 61 is switched off, and vice versa. An instantaneous current level of the supply current I21 can be controlled by controlling the duty-cycle of the PWM operation of the first switch 61, wherein the current level of the output current I21 increases as the duty-cycle increases. The duty-cycle of the PWM operation of the first switch 61 is given as D₆₁=Ton₆₁/T₆₁, where D₆₁ is the duty-cycle, Ton₆₁ is the on-period of the first switch 61 in one switching cycle, and T₆₁ is duration of the switching cycle. A duty-cycle D₆₂ of the second switch is substantially D₆₂=1−D₆₁.

A positive sinusoidal half-period of the supply current I2, I21 is obtained by suitably varying the duty-cycle D₆₁ of the first switch, wherein the current level of the supply current I2, I21 increases as the duty-cycle D₆₁ increases, and decreases as the duty-cycle D₆₁ decreases. FIG. 5 schematically shows several switching cycles of the first switch 61 during the positive half-period from where an increase followed by a decrease of the duty-cycle D₆₁ can be seen. It should be noted that the timing diagrams in FIG. 5 are only schematical. Usually, a switching frequency of the first and second switches 61, 62, which is the reciprocal of the switching period T₆₁ (f=1/T₆₁), is usually much higher than a frequency of the supply current I21. According to one embodiment, the switching frequency f is several 10 kHz up to several 100 kHz, while a frequency f_{SIN} of the sinusoidal supply current I21 is, for example, between 10 Hz and several few kHzz.

The generation of the negative half-period of the supply current I21 corresponds to the generation of the positive half-period with the difference that during the negative half-period the second switch 62 is switched on, the first switch 61 is switched off and the third and fourth switches 63, 64 are switched on and off in a PWM fashion. The signal level of the supply current I21 is defined by the duty-cycle D₆₂ of the PWM operation of the second switch 62, wherein the signal level increases as the duty-cycle D₆₂ increases. The fourth switch 64, similar to the second switch 62 in the first half-period, serves as a freewheeling element during the second half-period, and switches on, when the third switch 63 switches off and vice versa. The duty-cycle D₆₄ of the fourth switch 64 is: D₆₄=1−D₆₃.

Referring to FIGS. 3 and 4, the individual switches 61-64 can be implemented with a freewheeling element, such as a diode. These switches can block a voltage with a first polarity and conduct when the voltage has an opposite polarity. When the switches 61-64 are implemented as MOSFETs, integrated body diodes of the MOSFETs may serve as the freewheeling elements.

When the switches 61-64 are implemented with integrated freewheeling elements, the control schemes illustrated with reference to FIG. 5 can be modified such that during the positive half-period the first and fourth switch 61, 64 are driven in a PWM fashion. During off-periods of these switches 61, 64 the freewheeling elements of the second and third switch 62, 63 provide a current path. During the negative half-period the second and third switches 62, 63 are driven in a PWM fashion, and the freewheeling elements of the first and fourth switch 61, 64 provide a current path during off-periods of these switches 62, 63.

The power converter stages 21 of FIGS. 3 and 4 can be operated in continuous current mode (CCM), or a discontinuous current mode (DCM). In the CCM, the duty cycle of those switches operated in the PWM fashion is such that a current through the inductor 65 does not decrease to zero between two on-periods of the switches operated in the PWM fashion. In the DCM, the duty cycle of those switches operated in the PWM fashion is such that a current through the inductor 65 decreases to zero between two on-periods of the switches operated in the PWM fashion. In a further embodiment the power converter stages can be operated in a Zero-voltage switching mode, where the current between two on-periods changes its direction. This operation mode is disclosed in U.S. Pat. No. 8,026,704, which is incorporated herein by reference in its entirety.

Referring to the explanation above, the signal level of the supply current I2, I21 during the positive half-period can be varied by varying the duty-cycle D₆₁ of the first switch 61, and the signal level of the supply voltage V21 during the negative half-period can be varied by varying the duty-cycle D₆₃ of the third switch 63. The drive control unit 31 is configured to vary the duty-cycles D₆₁, D₆₃ in accordance with the timing diagrams of FIG. 5 such that the supply current I21 has a sinusoidal waveform. The back EMF (Electromagnetic Force) of the motor causes a sinusoidal voltage V21 and V2, respectively, when the supply current received by the motor has a sinusoidal waveform.

Further, the drive control unit 31 is configured to vary the frequency f_{SIN} of the supply current I21 dependent on a motor signal S_{M}. The motor signal S_{M} may indicate a desired rotational speed of the motor M, wherein the drive control unit 31 is configured to control the switches S61-S64 of the converter stage 21 such that the motor is driven with the desired rotational speed. The motor signal may further indicate a desired torque of the motor M. The torque of the motor can be adjusted by adjusting the amplitude of the supply current I21, I2, wherein the amplitude can also be adjusted by adjusting the duty-cycles of the control switches. Thus, the drive control unit 31 may further be configured to control the switches S61-S64 such that the supply current has a desired amplitude as defined by the motor signal S_{M}. Thus, drive control unit 31 operates like a conventional variable frequency drive (VFD) controller. This type of controller is commonly known, so that no further explanations are required in this regard.

Thus, in the drive mode, the power converter circuit 2, as controlled by the control circuit 3, varies the frequency of the supply current I2 available at the power supply bus 4 dependent on the motor control signal S_{M} such that the motor M is driven with a desired rotational speed and/or a desired torque. According to one embodiment the angle of the sinusoidal current fed to the motor may have a phase difference to the sinusoidal voltage created by the back EMF.

FIG. 6 schematically illustrates the battery current −I1 and the battery voltage V1 as controlled by the charge control unit 32 during the charging mode. During the charging mode, the battery current I1 flows in the direction opposite the directions illustrated in FIGS. 3 and 4, so that the battery current I1 has a negative sign in FIG. 6. According to one embodiment, the charge control unit 32 is configured to charge the battery in one of two different charging modes, namely a first charging mode that will be referred to as constant current mode in the following, and a second charging mode that will be referred to as constant voltage mode in the following. In the constant current mode, the charge control unit 32 controls the power converter circuit 2 to charge the battery with a substantially constant battery current I1, and in the constant voltage mode, the charge control unit 32 controls the power converter circuit 2 to keep the battery voltage V1 substantially constant. According to one embodiment, the charge control unit 32 is configured to operate the power converter circuit 2 in the constant current mode or the constant voltage mode dependent on a charge state of the battery 1. According to one embodiment, the charge state of the battery 1 is represented by the battery voltage V1, so that the charge control unit 32 receives a battery voltage signal S_{V1} representing the battery voltage V1. This battery voltage signal S_{V1} can be obtained in a conventional way by measuring the battery voltage V1.

Referring to the curves illustrated in FIG. 6, the charge control unit 32 operates the power converter circuit 2 in the constant current mode when the battery voltage V1 is below a maximum battery voltage V1_{MAX}. FIG. 6 shows the battery voltage V1 and the battery current −I1 over the time, wherein the charging process illustrated in FIG. 6 starts when the battery voltage V1 has decreased to a minimum voltage V1_{MIN}. As the battery 1 is charged with a constant charging current −I1_{REF} in the constant current mode, the battery voltage V1 usually increases. However, the linear increase illustrated in FIG. 6 is only one example.

Referring to FIG. 6, the charge control unit 32 changes to the constant voltage mode, when the battery voltage V1 reaches the maximum voltage V1_{MAX} that corresponds to a reference voltage V1_{REF} in the constant voltage mode. During the constant voltage mode, the battery current −I1 decreases. According to one embodiment, the charge control unit 32 stops the charging process when the charging current −I1 has decreased to a minimum charging current −I1_{MIN}. A decrease of the charging current to the minimum charging current indicates that the battery 1 has been fully charged.

The operating principle of the power converter circuit 2 in the charging mode is explained with reference to FIG. 7 in which timing diagrams of the supply voltage V2 and of the drive signals S61-S64 of the switches 61-64 of the power converter circuit 2 are illustrated. In FIG. 7, a high-level of one drive signal represents an on-level that switches the corresponding switch on, and a low-level that represents an off-level that switches the corresponding switch off.

In the charging mode, the supply voltage V2 available at the power supply bus is provided by an external power source (not illustrated in FIG. 1) coupled to the supply terminals 50, 51. The switching circuit 5 connects the supply terminals 50, 51 to the power supply bus 4 in the charging mode. Referring to FIG. 7, it is assumed that the supply voltage V2 has a sinusoidal waveform. FIG. 7 shows one period with a positive half-period and a negative half-period of the supply voltage V2. Dependent on whether the charge control unit 32 operates the power converter circuit 2 in the constant voltage mode, or the constant current mode, the control unit 32 either controls the battery current I1 or the battery voltage V1. In each case, the control includes driving at least one of the switches 61-64 in a PWM fashion and varying the duty-cycle of the PWM operation dependent on the signal (the battery voltage V1 of the battery current I1) to be controlled.

During the positive half-period of the supply voltage V2 the charge control unit 32 switches on the fourth switch 64 and switches off the third switch 63. The second switch 62 is switched on and off in a PWM fashion, wherein a duty-cycle D₆₂ of the PWM operation of the second switch 62 varies in order to control the output signal. The first and second switch 61, 62 are switched on an off complementarily, that is, the first switch 61 switches on when the second switch 62 switches off, and vice versa. A duty-cycle of the first switch 61 is substantially: D₆₁=1−D₆₂. In FIG. 7, a PWM operation of the first and second switches is only schematically illustrated.

During the negative half-period of the supply voltage V2 the charge control unit 32 switches on the third switch 63 and switches off the fourth switch 64. The first switch 61 is switched on and off in a PWM fashion, wherein a duty-cycle D₆₁ of the first switch 61 is varied in order to control the output signal (I1 or V1). The first switch 61 and the second switch 62 are switched on and off complementarily. That is, the second switch 62 switches on when the fourth switch 61 switches off. Thus, a duty-cycle D₆₂ of the second switch 62 is substantially, D₆₂=1-D₆₁.

When the switches 61-64 are implemented with freewheeling elements, the first switch 61 can be switched off during the positive half-period, and the second switch 62 can be switched off during the negative half-period, because the freewheeling elements of these switches 61 and 62, respectively, take the current during off-periods of second switch 62 and the first switch, respectively.

The operating principle of the power converter circuit 2 during the positive half-period of the supply voltage V2 is as follows. When the second and fourth switches 62, 64 are switched on, energy is magnetically stored in the inductor 65. When the second switch 65 switches off and the first switch 61 switches on, the energy stored in the inductor 65 is transferred to the battery 1. The output signal I1, V1 can be controlled by controlling the duty-cycle of the PWM operation of the second switch 62. During the negative half-period of the supply voltage V2, energy is magnetically stored in the inductor 65 when the first switch 61 and the third switch 63 are switched on. When the first switch 61 switches off and the second switch 62 switches on, the energy previously stored in the inductor is transferred via the third switch 63 to the battery 11. The output signal I1, V1 can be controlled by controlling the duty-cycle of the PWM operation of the first switch 61.

According to one embodiment, the charge control unit 32 does not only control the output signal, which is the battery current I1 in a constant current mode, and the battery voltage V1 in the constant voltage mode, but also controls the current I2 into the power converter circuit 2 such that this current is in phase with the supply voltage V2 provided through the supply terminals 50, 51. That is, the charge control unit 32 has a Power Factor Correction (PFC) functionality.

One embodiment of a charge control unit is illustrated in FIG. 8. FIG. 8 is a block diagram of the charge control unit 32 that illustrates the functionality rather than the implementation. The individual functional blocks of FIG. 8 can be implemented using analog circuitry, digital circuitry, or hardware and software.

Referring to FIG. 8, the charge control unit 32 includes a first controller 321 that receives a supply voltage signal S_{V2} that represents the supply voltage V2 and a supply current signal S_{I2} that represents the current −I2 from the power supply bus 4 into the power converter circuit 2. The first controller 321 outputs a first duty-cycle signal S_{DC1}. The first duty-cycle signal S_{DC1} controls the signal waveform of the supply current I2 to correspond to the signal waveform of the supply voltage V2. Since the signal waveform of the supply voltage V2 varies periodically, it is desired to also vary the supply current I2 periodically. Thus, the first duty-cycle signal S_{DC1} is generated by the first controller 321 such that it also varies periodically in order to meet the phase requirement explained before.

Referring to FIG. 8, the charge control unit 32 further includes a second controller 322 that outputs a second duty-cycle signal S_{DS2}. The second duty-cycle signal S_{DC2} serves to control the output signal, which is the battery current I1 in the constant charging mode and the battery voltage V1 in the constant voltage mode. The second controller 322 receives a reference signal S_{REF} that represents a desired signal level of the output signal to be controlled. In the constant current mode, the reference signal S_{REF} represents the reference current −I_{REF} of FIG. 7, and in the constant voltage mode, the reference signal S_{REF} represents the reference voltage V1_{REF} of FIG. 7. The second controller 322 further receives the output signal, which is either a battery current signal S_{I1} that represents the battery current I1, or a battery voltage signal S_{V1} that represents the battery voltage V1. A multiplexer 323 receives both of these signal S_{I1}, S_{V1} and dependent on and operation mode signal S_{MOD} forwards one of these signals to the second controller 322. The operation mode signal S_{MOD} is, for example, provided by the central processing unit 30 and represents the desired operation mode the charge control unit 32.

Referring to FIG. 8, a multiplier 324 receives the first duty-cycle signal S_{DC1} and the second duty-cycle signal S_{DC2} and outputs an overall duty-cycle signal S_{DC} that corresponds to the product of the first and second duty-cycle signals S_{DC1}, S_{DC2}.

A PWM generator 325 receives the overall duty-cycle signal S_{DC} and generates the drive signals S61-S64 in accordance with the timing diagrams explained with reference to FIG. 7. The PWM generator 325 further receives an information on the polarity of the supply voltage V2 in order to decide which of the switches 61-64 is switched on or switched off, and which of the switches is to be operated in a PWM fashion with a duty-cycle as defined by the duty-cycle signal S_{DC}. Referring to FIG. 7, the second switch 62 is operated in a PWM fashion during the positive half-period, so that during the positive half-period of the supply voltage V2 the drive signal S62 is generated with a duty-cycle as defined by the duty-cycle signal S_{DC}. During the negative half-period, the duty-cycle signal S_{DC} defines the duty-cycle of the fourth switch S64. According to one embodiment, the PWM generator 325 receives the supply voltage signal Sᵥ₂ and extracts the polarity information from this signal.

In an electric drive system according to embodiments explained herein before, the AC power supplied by the power converter circuit 2 in the drive mode can be transmitted over relatively long power supply bus lines. Unlike conventional electric drive systems that include a DC bus there is no need to place the power converter circuit 2 in close vicinity of the motor M. Thus, the battery 1 and the power converter circuit 2 can be realized as one unit, so that the battery terminals 11, 12 cannot be accessed. This eliminates the need for a battery disconnect switch that, in conventional systems is configured to disconnect the battery from the DC bus in case of an accident. In the present electric drive system, the power converter circuit 2 may act as a battery disconnect switch. According to one embodiment the power converter circuit 2 is controlled in such a way as to limit the current for a given time period and to shut off, if the current level exceeds a given threshold or if the time interval where the current exceeds a given threshold exceeds a given time period.

FIG. 9 illustrates a drive system according to a further embodiment. In this embodiment, further loads Z0, Z1, Z2 are coupled to the power supply bus 4. Dependent on the type of load, the additional loads can be connected to the power supply bus 4 in different ways. According to one embodiment, a load Z0 is directly connected to the power supply bus. This load Z0 is, for example, a resistor based heating system that directly receives the supply voltage V2 available at the power supply bus 4. The load Z0 may be regulated by switching the voltage V2 in an on/off mode to the load with for example a relay (not shown). Other loads such as loads Z1, Z2 of FIG. 9 are coupled to the power supply bus 4 through power converter circuits 71, 72. These power converter circuits 71, 72 can be unidirectional power converter circuits which transmit power from the power supply 4 bus to the individual loads Z1, Z2, but not in an opposite direction. The type of power converter circuit 71, 72 is dependent on the type of load. In the embodiment of FIG. 9, a first power converter circuit 71 coupled to the load Z1 is an AC/DC power converter circuit that receives the alternating supply voltage V2 and outputs a direct voltage V71 to the load Z1. This power converter circuit 71 can be a conventional AC/DC power converter circuit that is configured to receive an alternating input voltage and to output a controlled direct voltage. One embodiment of this AC/DC power converter circuit 71 is schematically illustrated in FIG. 10.

The power converter circuit of FIG. 10 is implemented as a buck converter and includes a series circuit with a switch 711, an inductor 712 and a capacitor 713 coupled to an output of a rectifier circuit 710, such as a bridge rectifier. The series circuit receives an output voltage V710 of the rectifier circuit 710 coupled to the power supply bus 4, wherein the output voltage is a rectified version of the supply voltage V2 available at the power supply bus 4. The output voltage V71 is available across the output capacitor 714. A PWM controller 715 operates the switch 711 in a PWM fashion dependent on an output voltage signal S_{V71} representing the output voltage V71 such that the output voltage V71 corresponds to a predefined reference voltage. A freewheeling element 714 is connected in parallel with the series circuit with the inductor 712 and the capacitor 713, wherein the freewheeling element 714 takes the current through the inductor 712 in those time periods in which the switch 711 is switched off.

According to one embodiment, the DC output voltage V71 of the power converter circuit 71 is about 12V. The load Z1 of FIG. 9 represents DC loads that can be used in a vehicle, such as motors for window lifters and seat adjustments, lighting, audio and entertainment systems, or the like.

Referring to FIG. 9, the second power converter circuit 72 may supply an alternating voltage V72 from the supply voltage V2. The load Z3 that receives the alternating voltage V72 represents loads in a vehicle that require an alternating supply voltage, such as an air-conditioning system. The second power converter circuit 72 can be a conventional AC/AC converter circuit that is configured to supply an alternating voltage from the alternating supply voltage V2. One embodiment of this power converter circuit 72 is schematically illustrated in FIG. 11.

Referring to FIG. 11, the power converter circuit 72 includes a first power converter stage 721 that receives an output voltage V720 from a rectifier circuit 720 coupled to the power supply bus 4. The output voltage V720 is a rectified version of supply voltage V2 available at the power supply bus. The first power converter stage 721 generates a direct supply voltage V721 from the alternating supply voltage V2. This supply voltage V721 will be referred to as DC link voltage in the following. The first converter stage 721 can be implemented with a conventional AC/DC converter topology, such as a buck converter topology (as illustrated in FIG. 10), a boost converter topology or a buck-boost converter topology.

Referring to FIG. 11, a second converter stage 722 receives the DC link voltage V721 and generates the alternating output voltage V72 with a desired frequency and amplitude. The second converter stage 722 includes a DC/AC converter topology. This topology can be a conventional DC/AC converter topology, such as a topology explained with reference to FIGS. 3 and 4.

The loads Z0-Z3 are supplied through the power converter circuits 71, 72 when the drive system is in the drive mode, and when the drive system is in the charging mode. In the drive mode, the supply voltage V2 is provided by the power converter circuit 2 connected between the battery 1 and the power supply bus, and in the charging mode, the supply voltage V2 is provided by the external power source connected to the power supply terminals.

Referring to the explanation above, the power converter circuit, in the drive mode, controls the supply current I2 provided to the power supply bus in accordance with the motor drive signal S_{M}, wherein the motor drive signal S_{M} includes information on the desired waveform parameters of the drive current I2, such as frequency, and amplitude. The power converter circuits 71, 72 supplying the loads Z1, Z2 and the load Z0 are configured to operate with a supply voltage V2 having a varying frequency and a varying amplitude resulting from the back EMF of the motor M receiving the supply current I2.

However, when the power converter circuit 2 is in the drive mode, but the motor drive signal indicates that the power consumption of the motor M is zero, the power converter circuit 2 reduces the amplitude of the supply current I2 to zero. In this case, other loads, such as loads Z0, Z1, Z2 shown in FIG. 9, would not be supplied any more. According to one embodiment, the control circuit 3 is configured to disconnect the motor M from the supply bus 4 using the switching circuit 5 (the supply bus 4 is then connected to the supply terminals 50, 51, that may not receive external power in this operation mode), and to control the drive control circuit 31 to generate one of a supply current I2 and a supply voltage V2 other than zero for driving the loads Z0, Z1, Z2. This supply voltage may have at least one of a fixed frequency and a fixed amplitude.

FIG. 12 illustrates a further embodiment of the power converter circuit 2 coupled between the battery 11 and the power supply bus 4. Besides the converter stage 21 explained before, the power converter circuit 2 of FIG. 12 additionally includes a further converter stage 20. The converter stage 21 will be referred to as first converter stage, and the further converter stage 20 will be referred to as second converter stage in the following. The second converter stage 20 is a DC/DC converter stage and is coupled between the battery 1 and the first converter stage 21. Like the DC/AC converter stage 21, the DC/DC converter stage 20 is a bidirectional converter stage that allows for a power transfer from the battery 1 to the DC/AC converter stage 21 and from the DC/AC converter stage 21 to the battery 1.

The DC/DC converter stage 20 is also controlled by the control circuit 3. According to one embodiment, in the power supply mode of the power converter circuit 2, the control circuit 3 controls the DC/DC converter stage 20 to supply an output voltage V20 (that will be referred to as DC link voltage V20 in the following). A signal level of the DC link voltage V20 can be higher than a signal level of the battery voltage V1, or can be lower than a signal level of a battery voltage V1. According to a further embodiment, the signal level of the DC link voltage V20 corresponds to the maximum signal level of the battery voltage V1, wherein the DC/DC converter stage 20 keeps the signal level of the DC link voltage V20 constant as the battery voltage V1 decreases when the battery 1 discharges.

The DC/DC converter stage 20 can be implemented with a conventional DC/DC converter topology as well known in the art.

Further, the DC/DC converter stage 20 may provide for a galvanic isolation between the battery 1 and the DC/AC converter stage 21. In this case, the DC/DC converter stage 20 includes a transformer or other means for galvanically isolating the battery 1 and the DC/AC converter stage 21 and enabling a power transmission in both directions (bidirectionally). In this case, the power converter circuit can be implemented with a topology as disclosed in FIGS. 1a and 1b of Everts, J.; Krismer, F.; Van den Keybus, J.; Driesen, J.; Kolar, J. W., “Comparative evaluation of soft-switching, bidirectional, isolated AC/DC converter topologies,” Applied Power Electronics Conference and Exposition (APEC), 2012 Twenty-Seventh Annual IEEE, pp. 1067-1074, Feb. 5-9, 2012 (“Everts”), which is disclosed herein by reference in its entirety. That is, the DC/DC converter 20 can be implemented with a Dual-Active Bridge topology as shown in FIGS. 2a and 2b of Everts, wherein the DC/DC converter 20 according to a first embodiment generates the voltage V20 as a direct voltage. In this case, the DC/AC converter 21 can be implemented as explained herein before.

According to a second embodiment, the DC/DC converter stage 20 controlled by the control circuit 3 is configured to supply a current with a rectified sinusoidal waveform as illustrated in FIG. 13 in the drive mode, and to receive a rectified sinusoidal voltage V20 in the charging mode. In this case, the DC/AC converter 21 acts as an unfolding bridge that generates the alternating supply current I21 from the rectified supply current I21. A waveform of this alternating current I21 is also shown in FIG. 23. The DC/AC converter 21 can be implemented with a topology as illustrated in FIG. 3, wherein the inductor 65 may be omitted. The operating principle of the converter 21 acting as an unfolding bridge is as follows. The converter 21 in one period of the periodical supply current I20 closes the first and fourth switch 61, 64, and in a next period closes the second and third switch 62, 63.

In the second embodiment, the drive control unit 32 drives the DC/DC converter 20 dependent on the motor signal S_{M} so as to vary at least one of the amplitude and the frequency of the rectified supply current I20 dependent on the motor signal S_{M}.

One embodiment of a DC/DC converter implemented with a Dual-Active Bridge Topology as disclosed in Everts is illustrated in FIG. 14. It should be noted that the DC/DC converter topology of FIG. 14 is only an example. Other bidirectional DC/DC converter topologies may be used as well.

Referring to FIG. 14, the DC/DC power converter stage 20 includes a first bridge circuit 201 with two half bridges each including a high-side switch 201₁, 201₃ and a low-side switch 201₂, 201₄ is connected between input terminals for receiving the battery voltage V1. A series circuit with an inductive storage element 203 and a primary winding 204p of a transformer 204 is connected between output nodes of the two half bridges, wherein an output node is a circuit node common to the high-side switch 201₁, 201₃ and the low-side switch 201₂, 201₄ of one half-bridge. The transformer 204 further includes a secondary winding 204_{S} that is inductively coupled with the primary winding 204_{P}. A second bridge circuit 205 with two half bridges each including a high-side switch 205₁, 205₃ and a low-side switch 205₂, 205₄ is coupled to the secondary winding 204_{S}. Each of these half-bridges is connected between an output (where the DC link voltage V20 or the rectified current I20 is provided) and includes an input. The input is a circuit node common to the high-side switch 205₁, 205₃ and the low-side switch 205₂, 205₄ of one half-bridge. The input of half-bridge 205₁, 205₂ is connected to a first terminal of the secondary winding 204, and the input of half-bridge 205₃, 205₄ is connected to a second terminal of the secondary winding.

The switches 201₁-201₄, 205₁-205₄ of the bridge circuits 201, 205 can be implemented as conventional electronic switches, such as MOSFETs (Metal-Oxide Field-Effect Transistors), IGBTs (Insulated Gate Bipolar Transistors), JFETs (Junction Field-Effect Transistors, HEMTs (High-Electron-Mobility Transistors), or the like. When the switches 205-207 are implemented as MOSFETs, an internal body diode of the MOSFETs can be used as rectifier element, so that no additional rectifier element is required.

According to one embodiment, a timing of switching on and switching off the individual switches 201₁-201₄ of the first bridge circuit 201 of the two half-bridges is such that at least some of the switches 201₁-201₄ are switched on and/or switched off when the voltage across the respective switch is zero. This is known as zero voltage switching (ZVS).

The DC/DC converter 20 can be operated bidirectionally. That is, the DC/DC converter 20, in the drive mode, can be operated to supply from the battery voltage V3 a substantially constant DC link voltage, or a supply current I20 with a rectified alternating waveform. In the charging mode, the DC/DC converter 20 may receive the voltage V20 with a substantially constant voltage level or with a rectified alternating waveform and charge the battery in one of the constant voltage and the constant current mode.

FIG. 15 illustrates a further embodiment of an electric drive system. The drive system of FIG. 14 additionally includes a generator G and a further power converter 8 coupled to the generator G. The generator G is, for example, a generator driven by a combustion engine and is configured to supply an alternating output voltage V_{G}. The further power converter circuit 8 receives the generator voltage V_{G} and supplies a DC voltage V8 at output terminals 81, 82 coupled to the power converter circuit 2.

According to one embodiment, illustrated in FIG. 16A, the output 81, 82 of the further power converter circuit 8 is coupled to the input of the power converter circuit 2 and, therefore, to the battery terminals 11, 12. According to one embodiment, the power converter circuit 8 is configured to supply one of a constant output voltage V8, and a constant output current I8 dependent on a charge state of the battery 1. The power converter circuit 2 can be implemented in accordance with each of the embodiments explained before. According to a further embodiment, illustrated in FIG. 16B, the power converter circuit 2 includes the DC/DC converter stage 20 and the DC/AC converter stage 21. In this case, the output 81, 82 of the further power converter circuit 8 is connected to the DC link capacitor 209 of the DC/DC converter stage 20.

The further power converter circuit 8 can be implemented with a conventional AC/DC power converter topology, such as a boost converter topology, a buck converter topology, or a buck-boost converter topology.

FIG. 17 illustrates a further embodiment of an electric drive system. The electric drive system of FIG. 17 includes a plurality of batteries 1_{I}, 1_{II}, 1_{III}, and a corresponding plurality of power converter circuits 2_{I}, 2_{I}, 2_{III}. Each of the power converter circuits 2_{I}, 2_{II}, 2_{III} is connected to an output 11_{I}, 12_{I}, 11_{II}, 12_{II}, 11_{III}, 12_{III} of one of the plurality of batteries 1_{I}-1_{III}. Although FIG. 17 shows a system with three batteries and three power converter circuits, the system is not restricted to three batteries and power converter stages. It is even possible to implement the system with only two or with more than three batteries and a corresponding number of power converter circuits. Each of the power converter circuits 2_{I}-2_{III} includes an output, wherein the outputs of the individual power converter circuits 2_{I}-2_{III} are commonly connected to the power supply bus 4. In the drive system of FIG. 17, one of the power converter circuits, such as a first power converter circuit 2_{I}, acts as a master converter that, in the drive mode controls the frequency and the amplitude of its supply current I2₁. The other power converter circuits act as slave converters that control their output currents to correspond to the output current of the master converter. In this case, the output current of each power converter circuit is 1/n of the overall supply current I2. According to another embodiment each of the slave power converter circuits may generate the supply current I21₂-I21ₙ with a frequency corresponding to the frequency of the output current I21₁ of the master power converter circuit and with an amplitude that is dependent on the capacity of the battery 1₂-1ₙ connected thereto, and such that the overall output current I2 has a predefined amplitude (in order to control the torque of the motor M).

Each of the individual power converter circuits 2_{I}-2_{III} can be implemented in accordance with one of the embodiments of the power converter circuit 2 explained herein before, and can be operated as explained in connection with these embodiments.

In the charging mode, each power converter circuit 2₁-2ₙ receives the supply voltage V2 (provided by the external power source) and charges the battery in accordance with one of the techniques described above.

Referring to FIG. 17, the control circuit 16 controls the individual power converter circuits 2_{I}-2_{III}, wherein each of these power converter circuits 2_{I}-2_{III}, as controlled by the control circuit 3, operates in the drive mode or in the charging mode. The control circuit 3 operates the individual power converter circuits 2_{I}-2_{III} simultaneously either in the drive mode or the charging mode.

FIG. 18 illustrates a further embodiment of a battery 1 and a power converter circuit 2 to be used in one of the drive systems explained herein before. In the embodiment of FIG. 17, the battery 1 includes a plurality of battery units (battery sections) 1₁, 1₂, 1ₙ, wherein each of these battery units 1₁-1ₙ is configured to supply a battery voltage V1₁, V1₂, V1ₙ between battery unit terminals 11₁, 12₁, 11₂, 12₂, 11ₙ, 12ₙ. The power converter circuit 2 includes a plurality of subcircuits 2₁, 2₂, 2ₙ wherein each of the subcircuits 2₁, 2₂, 2ₙ is coupled to the output of one of the battery units 1₁-1ₙ. Each of the subcircuits 2₁-2ₙ is controlled by the control circuit 3, wherein the control circuit 3 operates the individual subcircuits 2₁-2ₙ simultaneously either in the drive mode or in the charging mode. In the drive mode, each subcircuit 2₁-2ₙ outputs a supply voltage V2₁-Vₙ with a frequency as defined by the control circuit 3. The individual subcircuits 2₁-2ₙ are cascaded such that the supply voltage V2 of the power supply bus 4 corresponds to the sum of the individual output voltages V2₁-V2ₙ of the subcircuits.

In the charging mode, output capacitors of the individual subcircuits 2₁-2ₙ form a capacitive voltage divider, so that voltage V2₁-V2ₙ at the output of the each subcircuit 2₁-2ₙ is a portion of the supply voltage V2 supplied by the external power source via the supply terminals (not illustrated in FIG. 17). Each of the sub circuits 2₁-2ₙ can be implemented like the first power converter circuit 2 explained with reference to FIGS. 1 to 16 herein before. When, for example, the individual subcircuits 2₁-2ₙ are implemented with converter stages 21 as explained with reference to FIGS. 3 and 4, the output capacitors shown in FIG. 16 correspond to the optional output capacitors 66 of FIGS. 3 and 4.

In the charging mode, each of the subcircuits 2₁-2ₙ is operated by the control circuit 3 like the first power converter circuit 2 explained with reference to FIGS. 1 to 16 herein before, with the difference that the subcircuits 2₁-2ₙ do not receive the overall supply voltage V2, but only receive a portion of the overall supply voltage V2.

FIG. 19 illustrates a further embodiment of an electric drive system. In the embodiment of FIG. 19, the power supply bus 4 is a 3-phase power supply bus that includes a first phase 41 (that is also referred to as R), a second phase 42 (that is also referred to as S), and a third phase 43 (that is also referred to as T). In this embodiment, the power converter circuit 2, in the drive mode, is configured to supply three output currents I2_{R}, I2_{S}, I2_{T}, one in each phase 41, 42, 43 that each have a frequency and an amplitude defined by the motor control signal (S_{M}, not illustrated in FIG. 19). A phase difference between two of these supply currents I2_{R}, I2_{S}, I2_{T} is about 120°. The power converter circuit 2 operates like a conventional 3-phase motor inverter that is configured to supply a 3-phase supply current with a frequency and an amplitude defined by a motor control signal.

The neutral 40 (N) is optional in this drive system. If, for example, the electric drive system includes a further load, such as one or more of the loads Z0, Z1, Z2 illustrated in FIG. 9, the load or the corresponding power converter circuit can be connected to the neutral and one of the phases 41, 42, 43.

The motor M is a 3-phase asynchronous motor in this embodiment, wherein the switching circuit 5 is configured to connect the motor to the three phases 41, 42, 43. The external power source can be a 3-phase source. In this case, the drive system includes four terminals, namely a first terminal 51 for the first phase of the power source, a second terminal 52 for a second phase of the power source, a third terminal 53 for a third phase of the power source, and a fourth terminal 50 for the neutral 40 of the power source. The switching circuit 5 is configured to either connect the power supply bus 4 to the external power, wherein each of the three phase terminals 51-53 to one of the phases 41-43, or to connect the power supply bus 4 to the motor M.

In case the external power source is only a single phase power source, the external power source is only connected to one of the three phase terminals 51-52 and the neutral terminal 50, and the switching circuit 5 is configured to connect the one of the three phase terminals 51-53 to one of the phases 41-43 of the power supply bus 4, and to connect the neutral terminal 50 to the neutral 40, in the charging mode.

In the embodiment of FIG. 19, there is only one motor that can be coupled to the power supply bus 4 by the switching circuit 5. However, this system could be easily modified to include a plurality of motors, such as brushless permanent magnet motors directly mounted within the wheel of vehicle. In this embodiment, the system includes a plurality of circuits each including a battery 1, a power converter circuit 2, a control circuit 3, a power supply bus and a motor M. The switching circuits of these circuits can be configured to connected the corresponding power supply bus either to the corresponding motor (in the drive mode) or to supply terminals. Wherein the individual circuits may share the supply terminals.

Two different embodiments of the power converter circuit 2 of FIG. 19 are explained with reference to FIGS. 20 and 21 below. Referring to FIG. 20, the power converter circuit 2 includes three DC/AC converter stage 21₁, 21₂, 21₃, wherein each of these power converter stages 21₁, 21₂, 21₃ is coupled between the battery 1 and one of the three phases 41-43 of the power supply bus 4. Optionally, the DC/DC power converter 20 stage is connected between the battery 1 and the power converter stages 21₁-21₃. Each of the power converter stages 21₁-21₃ includes a half-bridge with a high-side switch 61₁-61₃, and a low-side switch 62₁-62₃, and includes an inductor 65₁-65₃, wherein the inductor of each power converter stage 21₁-21₃ is coupled between the output of the corresponding half-bridge and the corresponding phase 41-42. The individual switches 61₁-61₃, 62₁-62₃ can be implemented with a freewheeling element (not illustrated) like the switches explained with reference to FIGS. 3 and 4.

Like the first power converter circuits 2 explained before, the power converter circuit 2 of FIG. 20 can be operated in a drive mode (power supply mode), in which the individual power converter stages 21₁-21₃ of power converter circuit 2 generate the power supply voltages V2_{R}, V2_{S}, V2_{T} from the battery voltage V1 or the DC link voltage V20 respectively. The control circuit 3 controls the individual power converter stages 21₁-21₃ such that the supply voltages V2_{R}, V2_{S}, V2_{T} have a sinusoidal waveform with an adjustable frequency, wherein a phase difference between the individual V2_{R}, V2_{S}, V2_{T} is substantially 120°.

Further, the power converter circuit 2 can be operated in a charging mode, in which the power converter circuit 2 receives the supply voltages from the power supply bus and either controls the battery current I1 or the battery voltage V1, or controls the DC link voltage V20.

FIG. 21 shows a first power converter circuit 2 according to a further embodiment. The embodiment of FIG. 20 is based on the embodiment of FIG. 19 with the difference, that the power converter circuit of FIG. 20 includes only one inductor 65 that is connected between the battery 1 or the DC/DC converter stage 20, respectively, and the half-bridges of the power converter stages 21₁-21₃. That is, the individual power converter stages 21₁-21₃ share the inductor 65. Further, each converter stage includes a capacitor 67₁, 67₂, 67₃ connected between the corresponding phase and a circuit node common to the individual capacitors 67₁, 67₂, 67₃. For bidirectional power flow the switches 61₁-61₃ and 62₁-62₃ can be implemented as bidirectionally blocking and conducting switches.

The power converter topologies of FIGS. 20 and 21 and their operating principle is disclosed in Kolar, J. W.; Friedli, T., “The essence of three-phase PFC rectifier systems,” mentioned above.

A 3-phase power converter circuit could further be implemented by using three of the power converter circuits explained with reference to FIGS. 3 and 4 and by driving these power converter circuits such that, in the drive mode, each power converter circuit generates one supply current to one phase and such that these currents have a phase difference of substantially 120°.

FIG. 22 illustrates another embodiment of an electric drive system. In this embodiment, the power converter circuit 2, in the drive mode, is configured to generate the supply current I2 with the waveform of a rectified alternating voltage, such as a rectified sinusoidal voltage V2, and, in the charging mode, is configured to receive a rectified alternating voltage. One embodiment of the supply current I2 having a rectified sinusoidal waveform is schematically illustrated in FIG. 22.

The power converter circuit 2 can be implemented with a topology that is based on the topology explained with reference to FIGS. 3 and 4, and that is simplified by omitting the third switch 63 and by replacing the fourth switch 64 with a permanent connection. The power converter circuit 2 is then operated like explained with reference to the positive half-period of the output voltage V2 herein before.

Referring to FIG. 22, the electric drive system further includes a rectifier circuit 91 coupled to the supply terminals 50, 51 and configured to generate a rectified voltage from the alternating supply voltage provided by the internal power source (not illustrated). Further, the electric system includes an unfolding bridge that is configured to generate an alternating voltage from the rectified supply current I2 provided by the first power converter circuit 2 in the drive mode. According to one embodiment, illustrated in FIG. 24, the unfolding bridge includes a bridge circuit with two half-bridges each including a high-side switch 921, 923, and a low-side switch 922, 924. Each half-bridge includes an output wherein one output is coupled to a first motor terminal M0, and the other output is coupled to the second motor terminal M2. The switches 921-924 are switched with the frequency of the rectified supply voltage V2 such that in one period of the rectified supply voltage V2 the first and fourth 921, 924 switch are conducting, while in the next period the second and third switch 922, 923 of the unfolding bridge 92 is conducting.

In the electric drive system explained hereinbefore, the power converter circuit 2 serves both, for providing the supply voltage V2 with a varying frequency, and for charging the battery. Thus, no additional battery charger is required. Further, the power converter circuit 2 is designed to have a maximum output power that is at least the maximum input power of the motor. However, the power converter circuit 2 is not only configured to supply the maximum power to the motor in the drive mode, but is also configured to supply the maximum power to the battery 1 in the charging mode, so that the battery can be charged faster than with a conventional battery charger.

According to one embodiment, a relays (not shown) is connected between the power converter circuit 2 and each phase of the power supply 4. Unlike conventional systems that include a DC bus, a simple and cheap relays (that is not necessarily configured to prevent electric arcs) can be used in the system with the AC bus 4 as explained before.

In the description hereinbefore, directional terminology, such as “top,” “bottom,” “front,” “back,” “leading,” “trailing” etc., is used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims and their legal equivalents.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An electric drive system comprising:
a rechargeable battery;
a power supply bus;
a first power converter circuit coupled between the rechargeable battery and the power supply bus;
a motor configured to be coupled to the power supply bus; and
a control circuit configured to operate the first power converter circuit in one of a power supply mode and a battery charging mode, wherein, in the power supply mode, the first power converter circuit supplies at least one of an alternating current and a rectified alternating current to the power supply bus and wherein, in the battery charging mode, the first power converter circuit charges the rechargeable battery.

2. The electric drive system of claim 1, further comprising:
power supply terminals; and
a switching circuit coupled between the power supply bus and the power supply terminals, and coupled between the power supply bus and the motor.

3. The electric drive system of claim 2, wherein the first power converter circuit is configured to supply a rectified alternating current to the power supply bus, and wherein the electric drive system further comprises:
an unfolding bridge circuit connected between the switching circuit and the motor; and
a rectifier circuit connected between the power supply terminals and the switching circuit.

4. The electric drive system of claim 1, wherein the power supply bus comprises one phase and a neutral and the motor is a single phase motor.

5. The electric drive system of claim 1, wherein the power supply bus comprises three phases and wherein the motor is 3-phase motor.

6. The electric drive system of claim 1, wherein the first power converter circuit, in the charging mode, is configured to operate in one of a constant current mode in which the battery is supplied with a substantially constant charging current, and a charging mode in which the battery is supplied with a substantially constant voltage.

7. The electric drive system of claim 1, wherein the first power converter circuit comprises:
a first power converter stage connected to the power supply bus; and
a second power converter stage connected between the rechargeable battery and the first power converter stage.

8. The electric drive system of claim 7, wherein, in the power supply mode of the first power converter circuit,
the second power converter stage is configured to supply a direct voltage to the first power converter stage, and
the first power converter stage is configured to generate the at least one alternating current from the direct voltage received from the second power converter stage.

9. The electric drive system of claim 7, wherein, in the power supply mode of the first power converter circuit;
the second power converter stage is configured to supply a current with a rectified alternating waveform to the first power converter stage; and
the first power converter stage is configured to generate the at least one alternating current from the current received from the second power converter stage.

10. The electric drive system of claim 9, wherein the rectified alternating waveform is a rectified sinusoidal waveform.

11. The electric drive system of claim 1, wherein the battery includes a plurality of battery units and the first power converter circuit includes a plurality of subcircuits, wherein each subcircuit is connected to one battery unit and wherein the subcircuits are cascaded.

12. The electric drive system of claim 1, comprising a plurality of batteries and a plurality of power converter circuits, wherein each of the plurality of power converter circuits is connected between one of the plurality of batteries and the power supply bus.

13. The electric drive system of claim 1, further comprising:
a generator; and
a second power converter circuit coupled to the first power converter circuit.

14. The electric drive system of claim 1, further comprising a load coupled to the power supply bus.

15. The electric drive system of claim 14, further comprising a further power converter circuit coupled between the load and the power supply bus.

16. A method comprising:
operating a first power converter circuit coupled between a rechargeable battery and a power supply bus in one of a power supply mode in which the first power converter circuit supplies at least one of an alternating current and a rectified alternating current to the power supply bus, and a battery charging mode in which the first power converter circuit charges the rechargeable battery from an external power source configured to be coupled to the power supply bus; and
driving a motor connected to the power supply bus in the power supply mode.

17. A circuit comprising:
a first power converter circuit to be coupled between terminals for a rechargeable battery and for a power supply bus; and
a control circuit configured to cause the first power converter circuit to operate in one of a power supply mode and a battery charging mode, wherein, in the power supply mode, the first power converter circuit supplies an alternating current to the terminals for the power supply bus and wherein, in the battery charging mode, the first power converter circuit charges the rechargeable battery.

18. The circuit of claim 17, wherein the alternating current comprises a rectified alternating current.

19. The circuit of claim 17, wherein the power supply bus comprises a power supply bus configured to supply power to a motor.
